(19) United States
(12) Patent Application Publication
(10) Pub. No.: US 2007/0006742 A1
(43) Pub. Date: Jan. 11, 2007

(54) Food spinner with suction device and brake

(75) Inventors: Charles S. Paradise, New York, NY (US); Yohanan Siskindovich, Brooklyn, NY (US); Louis F. Henry, Scarsdale, NY (US)

Correspondence Address: LATHROP & GAGE LC, 2345 GRAND AVENUE, SUITE 2800, KANSAS CITY, MO, 64108, US

(73) Assignee: Design For Living, L.L.C.

(21) Appl. No.: 11/302,298

(22) Filed: Dec. 13, 2005

Related U.S. Application Data
(63) Continuation-in-part of application No. 29/232,222, filed on Jun. 16, 2005.
(63) Continuation-in-part of application No. 29/232,229, filed on Jun. 16, 2005.
(63) Continuation-in-part of application No. 29/232,215, filed on Jun. 16, 2005.
(63) Continuation-in-part of application No. 29/232,220, filed on Jun. 16, 2005.
(63) Continuation-in-part of application No. 29/232,225, filed on Jun. 16, 2005, now Pat. No. D530989.
(63) Continuation-in-part of application No. 29/232,321, filed on Jun. 16, 2005, now Pat. No. D519802.
(63) Continuation-in-part of application No. 29/232,217, filed on Jun. 16, 2005, now Pat. No. D530992.
(63) Continuation-in-part of application No. 29/232,271, filed on Jun. 16, 2005.
(63) Continuation-in-part of application No. 29/232,218, filed on Jun. 16, 2005, now Pat. No. D532261.
(63) Continuation-in-part of application No. 29/232,248, filed on Jun. 16, 2005.
(63) Continuation-in-part of application No. 29/232,226, filed on Jun. 16, 2005.
(63) Continuation-in-part of application No. 29/232,228, filed on Jun. 16, 2005, now Pat. No. D521287.
(63) Continuation-in-part of application No. 11/239,921, filed on Sep. 30, 2005.
(63) Continuation-in-part of application No. 11/241,332, filed on Sep. 30, 2005.

(51) Int. Cl. A23B 4/03

(52) U.S. Cl. 99/479

(57) ABSTRACT

A food spinner with a lid assembly that contains gears and a brake. The brake impinges upon at least one gear of the spinner to slow and stop the spinner. The brake has frictional material on a surface that contacts the gear. The brake is moved into contact with the gear by pressing a button on the lid of the spinner. The food spinner is secured to a work surface by a compact suction device contained in a base of the spinner.

### RELATED APPLICATIONS

This application is a continuation-in-part of U.S. patent application Ser. No, 29/232,222, filed Jun. 16, 2005; U.S. patent application Ser. No. 29/232,229, filed Jun. 16, 2005; U.S. patent application Ser. No. 29/232,215, filed Jun. 16, 2005; U.S. patent application Ser. No. 29/232,220, filed Jun. 16, 2005; U.S. patent application Ser. No. 29/232,225, filed Jun. 16, 2005; U.S. patent application Ser. No. 29/232,321, filed Jun. 16, 2005; U.S. patent application Ser. No. 29/232,217, filed Jun. 16, 2005; U.S. patent application Ser. No. 29/232,271, filed Jun. 16, 2005; U.S. patent application Ser. No. 29/232,218, filed Jun. 16, 2005; U.S. patent application Ser. No. 29/232,248, filed Jun. 16, 2005; U.S. patent application Ser. No. 29/232,226, filed Jun. 16, 2005; U.S. patent application Ser. No. 29/232,228, filed Jun. 16, 2005; U.S. patent application Ser. No. 11/239,921, filed Sep. 30, 2005 and U.S. patent application Ser. No. 11/241,332, filed Sep. 30, 2005. The aforementioned applications are incorporated herein by reference.

### FIELD OF INVENTION

This invention relates generally to kitchenware and, in particular, a salad and food spinner with a convenient and dependable brake structure.

### BACKGROUND OF INVENTION

Salad spinners are used to remove excess or undesired moisture from lettuce and other leafy foods that have been washed or rinsed before they are combined with other foods for human consumption. The leafy food is placed in the spinner, the spinner is rotated, usually at a relatively high speed to remove the water from the leaves, and then stopped so that the leafy food may be removed from the spinner. Due to the speed at which the spinner rotates and the uneven distribution of the food therein, the spinner may have a tendency to move on the work surface or even fall off the work surface. Also, and again due to the speed of the spinner, it may be difficult to stop the spinner once the water or other liquid has been spun off the leaves. The user may at times have to wait until the spinner has slowed down in order to stop it.

It would be desirable to have a salad and food spinner that could be easily and firmly secured to a counter or work surface during the spinning operation. It is also desirable to have a low profile device for securing the spinner to the work surface so that the spinner assemble itself does not become bulky or unnecessarily or uncomfortably high for the user when it is secured to the work surface. It would also be desirable to have a food spinner that had a braking device that could be easily activated and could stop the spinner in a very short period of time, again without causing the spinner to move or become unstable on the counter or work surface.

### SUMMARY OF INVENTION

The salad and food spinner of the invention has a suction device in the base. The suction device is engaged and disengaged by a lever that is moved horizontally in a slot in the base to secure the spinner very firmly to the work surface. The suction device has low profile so that the spinner assemble itself does not become bulky or unnecessarily or uncomfortably high for the user when it is secured to the work surface.

The spinner is also equipped with a brake that quickly and dependably stops the spinner and is activated by simply pressing a button in the top of the lid of the spinner.

### BRIEF DESCRIPTION OF THE DRAWINGS

FIG. 1 is a perspective view of the food spinner of the invention;

FIG. 2 is an exploded view of the food spinner;

FIG. 3 is a cross sectional side view of the assembled food spinner;

FIG. 4 is a perspective view of a brake and first, second, and third gears of the food spinner; and

FIG. 5 is an exploded view of a basket, a basket top, a lid base, the first gear, the second gear, the third gear, the brake, a lid top, and a handle of the food spinner.

### DETAILED DESCRIPTION

Certain terminology will be used in the following description. Words such as “top”, “bottom”, “upper”, “lower”, “upward”, “downward”, “rightward”, “leftward”, “above”, “below”, and the like, refer to those same directions in the properly oriented drawings. Words such as “inward”, “outward”, “inner”, “outer”, “central”, refer to the same directions or locations at, toward, or away from the geometric center of the object shown or referenced in the properly oriented drawings. This use of such terminology is for convenient reference, is not intended to be limiting (as, for example, if an embodiment of the invention is inverted or reversed), and includes the words specifically mentioned, derivatives thereof, and words of a similar nature or import.

Food Spinner Assembly

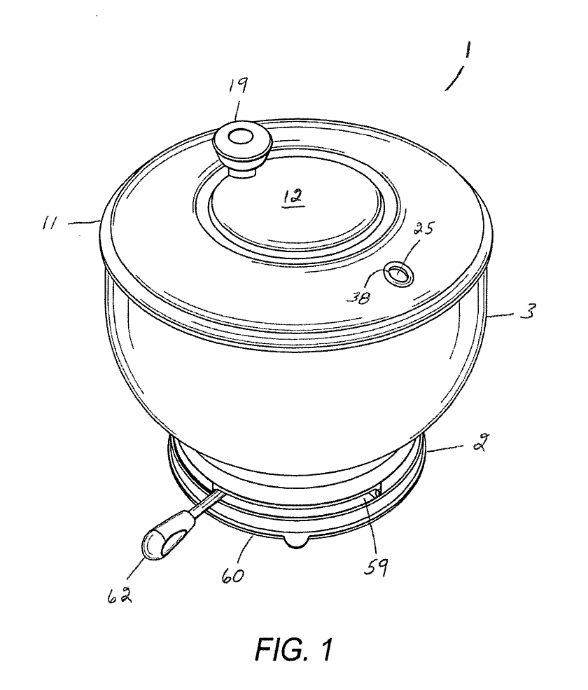

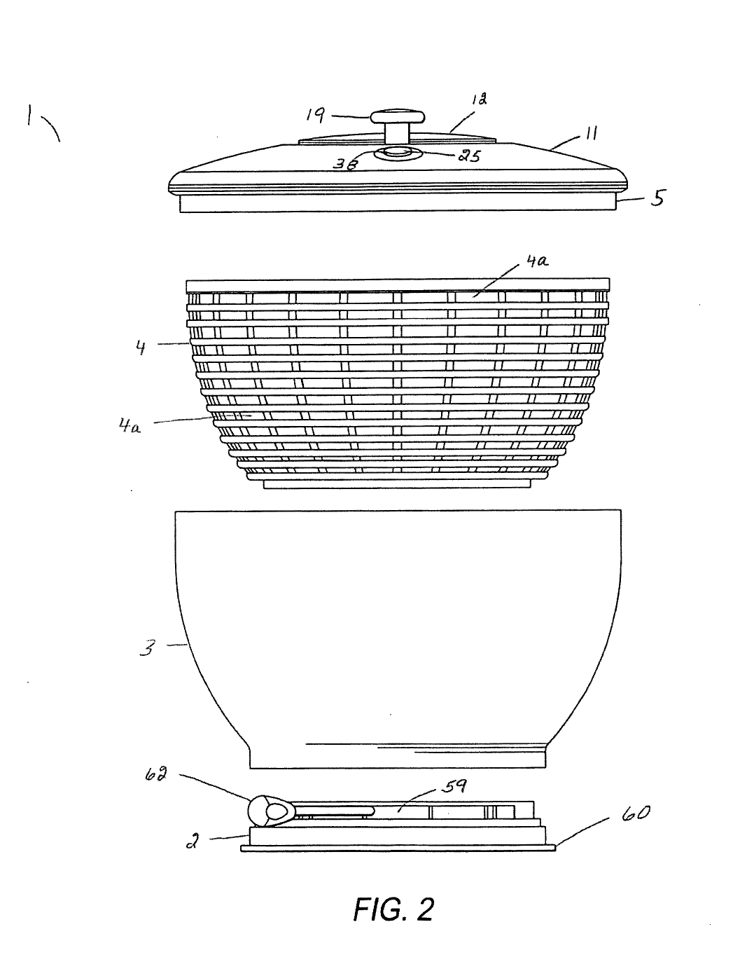

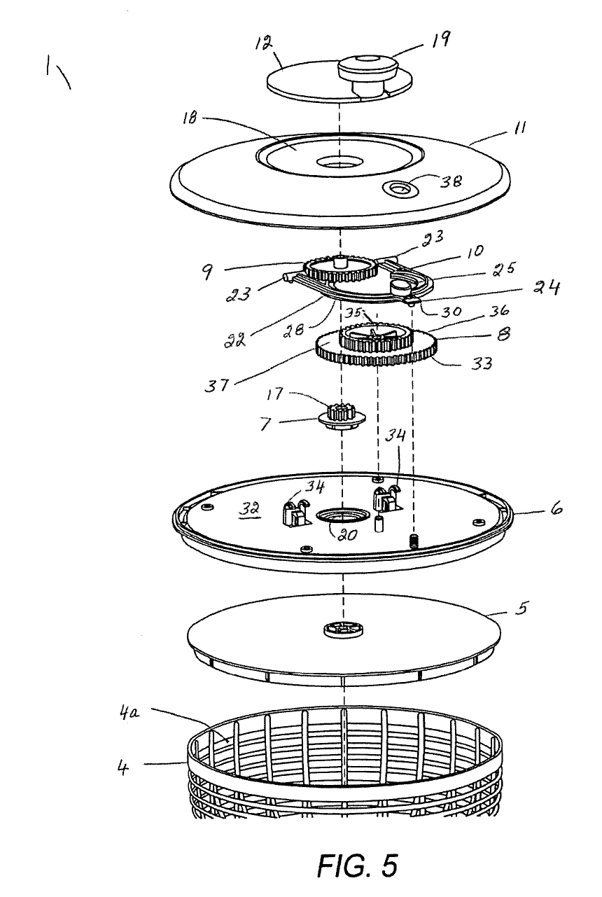

As shown in FIGS. 2 and 5, a food spinner 1 of the invention has a base 2, a bowl 3, a basket 4, a basket top 5, a lid base 6, a first movable toothed gear 7, a second movable toothed gear 8, a third movable toothed gear 9, a brake 10, a lid top 11, and a handle 12. The assembled food spinner is show in FIG. 1.

The base 2 may be removably or permanently secured to the bowl 3. See FIGS. 1 and 2.

The basket 4 is made of a lattice type structure so that it has a multitude of openings 4a in its side. The basket 4 is sized to fit within the bowl 3 so that it may rotate within the bowl 3, as shown in FIGS. 1, 2, and 3.

As shown in FIGS. 1, 2, 3, and 5, the basket top 5 is sized to be removably placed on top of the basket 4 in a friction fit such that, when the basket top 5 is rotated, the basket 4 rotates as well.

The above listed parts of the food spinner 1 may be made of plastic or metal or a combination thereof. However, a durable plastic is preferred.

Food Spinner Handle and Gears

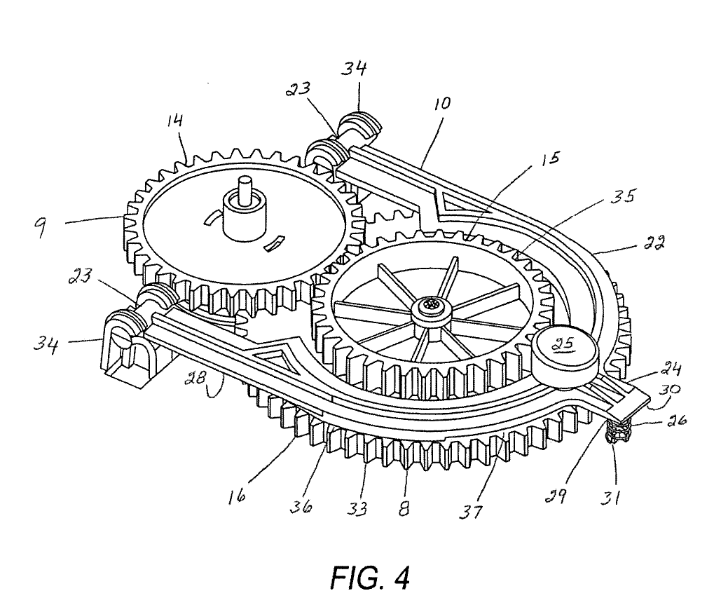

As shown in FIG. 5, the handle 12 is attached to the third movable toothed gear 9, at connector 13. The teeth 14 of the third movable gear cooperate and mesh with the spaces between the upper teeth 15 of the second movable gear 8. (See FIG. 4) The lower movable teeth 16 of the second gear 8 cooperate and mesh with the spaces between the teeth 17 of the first movable gear 7. The first gear 7 is connected to the basket top 5, and the basket top 5 is firmly, but removably secured to the basket 4. Thus, as the handle 12 is rotated, the third, second, and first gears 9, 8 and 7 rotate, the basket top 5 rotates, and the basket 4 rotates and spins.

The handle 12 is movably positioned in a recession 18 of the lid top 11. The handle 12 has a grip 19 that is used to rotate the handle 12 in the recession 18 and, as described above, to rotate the basket 4.

Lid Assembly

The lid top 11 and the lid base 6 are secured to one another and house the gears 7, 8, and 9 and the brake 10. The first gear 7 is connected to the basket top 5 through a hole 20 in the lid base 6. The basket top 5 does not separate from the lid base 6 during normal use. Thus, when the connected lid top 11 and lid base 6 are removed or lifted from the food spinner 1, the basket top 5 is also removed from the basket 4.

Brake Assembly

As shown in FIG. 4, the brake 10 comprises a U-shaped frame 22 having hinge bars 23, a frame projection 24, a button 25, and a spring 26.

As shown in FIG. 5, the button 25 is attached to the projection 24 of the brake frame 22. Rubber or some other frictional material (not shown) is bonded or attached to the underside 28 of the U-shaped frame 22. The frictional material may be rubber, plastic, metal, or other material that creates friction between the gear 8 and the underside 28 of the frame 22. In many cases the addition of the frictional material may not be necessary, because the surfaces of the brake frame 22 and the gear 8 may be such that sufficient friction is created therebetween when they are brought in contact with one another.

An upper end 29 of the spring 26 is attached to or rests against an underside 30 of the frame projection 24. A lower end 31 of the spring 26 is attached to or rests upon an upper side 32 of the lid base 6. The spring 26, when unbiased, is slightly longer or taller than the thickness of a lower toothed portion 33 of the second gear 8.

The hinge bars 23 fit movably within cooperatively shaped hinge receivers 34 on the lid base 6. When the button 25 is pressed, the spring 26 is compressed, and the U-shaped frame 22 pivots downward as the hinge bars 23 rotate within the hinge receivers 34. When the button 25 is released, the hinge bars 23 rotate in the opposite direction, and the frame 22 moves upward via the bias of the spring 26.

As shown in FIG. 4, the lower portion 33 of the second gear 8 is larger in diameter than an upper portion 35 of gear 8. The top 36 of the lower portion 33 of the second gear 8 thus presents a substantially flat surface 37 that is not overlapped by the upper portion of 35 of second gear 8. The U-shaped brake frame 22 is positioned just above the flat surface 37 of the lower portion 33 of the second gear 8 and is held in that position by the spring 26 when the spring 26 is not compressed. When the button 25 is pressed, the frame 22 and its extension 24 are moved downward against the bias of the spring 26. As the frame 22 is moved downward, the rubber or other material attached to the underside 28 of frame 22 makes contact with the flat surface 37 on the top 36 of the lower portion 33 of the second gear 8 and prevents the second gear 8 from moving. Of course, if the second gear 8 is moving when the button 25 is pressed, the rubber or other frictional material on the underside 28 of frame 22 makes frictional contact with the flat surface 37 of on the top 36 of the lower portion 33 of the second gear 8 and slows the second gear 8 or stops its movement. When the button 25 is released, the brake frame 22 rises in response to the bias of the spring 26 so that it is once again positioned just above, and not in contact with, the flat surface 37 on the top 36 of the lower portion 33 of the second gear 8, in which position it does not hinder or interfere with the rotation of the gear 8.

The button 25 that activates the brake 10 extends through a hole 38 in the lid top 11 so that the button 25 can be pressed, and the brake 10 activated, from the lid top 11. (See FIG. 5)

Base Suction Device

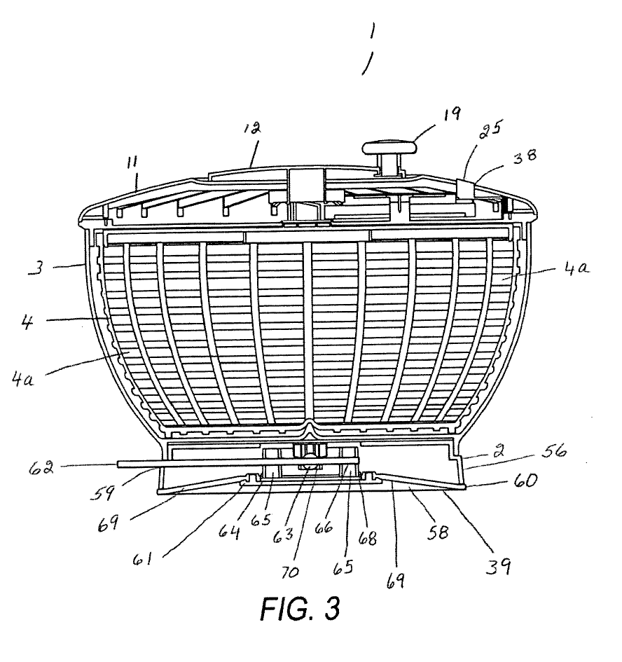

The base 2 of the food spinner 1 houses a suction assembly 39, as shown in FIG. 3.

The suction assembly 39 comprises a suction pad 60, a suction pad plate 61, a handle 62, and a pivot 63. The suction plate 61 has a top side 64. Two spaced-apart bridge-like structures 65 extend away and upward from the top side 64 of the plate 61. Each bridge-like structure 65 has an underside 66 that is ramped or sloped. The pivot 63 is situated between the bridge-like structures 65.

The suction pad 60 is larger in diameter than the suction pad plate 61. The suction pad has a central portion 68 and an outer portion 69. When the suction pad 60 is placed on the top side 64 of the suction pad plate 61, the outer portion 69 of the suction pad 60 extends beyond and outward from the suction pad plate 61. The central portion 68 of the suction pad 60 is situated on and connected to the top side 64 of the plate 61.

The handle 62 extends from the sloped underside 66 of one of the bridge-like structures 65, through a hole 70 in the pivot 63, along the sloped underside 66 of the other bridge-like structure 65, and outward thorough the elongated slot 59 in the side 56 of the base 2 above the bottom opening 58 of the base 2. The handle 62, so situated, is in sliding contact with the sloped undersides 66 of the bridge-like structures 65.

The suction assembly 39 is oriented so that the outer portion 69 of the suction pad 60, which extends outward from the plate 61, makes contact with the counter or work surface through the bottom opening 58 of the base 2.

Suction device 39 is operated by moving its handle 62 from one side of its elongated slot 59 to the other.

Movement of the handle 62 in one direction causes the handle 62 to slide along the upward slopes of the underside 65 of the bridge-like structures 65. As the handle 62 slides along the slope underside 65, it pulls the plate 61 from which the bridge-like structures 65 extend, in turn causing the plate 61 to pull the central portion 68 of the suction pad 60 away from the counter, while the outer portion 69 of the suction pad 60 remains in contact with the counter. As the central portion 68 of the suction pad 60 is pulled away from the surface, the air pressure between the central portion 68 of the suction pad 60 and the counter decreases, creating a partial vacuum under the central portion 68 of the suction pad 60, which, in turn causes the outer portion 69 of the suction pad 60, which is still in contact with the counter, to adhere to the counter.

Movement of the handle 62 in the opposite direction in the slot 59 relaxes the central portion 68 of the suction pad 60, causes the central portion of the suction pad 60 to move toward the counter, increases the pressure under the central portion 68 of the suction pad 60, dispels the partial vacuum, and allows the suction pad 60 to be easily removed from the surface to which it is was formerly mated.

Operation of the Suction Device

The food spinner 1 is placed in a desirable location on a work surface or counter. In this position, the outer portion 69 of the suction pad 60 is in contact with the countertop. The handle 62 of the suction device 39 is moved in the elongated slot 59. As the handle 62 moves in the slot 59 the central portion 68 of the suction pad 60 is raised upward, creating a partial vacuum under the central portion 68 of the suction pad 60 while the outer portion of the 69 of the suction pad 60 remains on the countertop. The vacuum or suction so created under the central portion 68 of the suction pad causes the food spinner 1 to stick or adhere to the counter in the desired location.

So adhered, the food spinner 1 will not be moved or tipped on the counter or work surface when the food spinner 1 is in operation.

If it is desired to move the food spinner 1 to a different location, the handle 62 of the suction device 39 is moved in the opposite direction in the slot 59 in the side 56 of the base 2 to relieve the partial vacuum under the central portion 68 of the suction pad 60. The food spinner 1 may then be moved to a different location on the countertop, where it may again be adhered by suction in the manner stated above.

Operation of Food Spinner

In use, the food spinner 1 is secured to the counter or work surface by placing the food spinner 1 on the work surface and activating the suction device 39 as described immediately above.

The lid top 1 laid base 6/basket top 5, all of which are connected, are lifted and removed from the food spinner 1. When the basket top 5 is removed or lifted from the food spinner 1, the basket top 5 is also removed from the basket 4. Lettuce, leafy greens, or other washed, wet, or moisture-containing food is then placed in the open basket 4. The basket top 5, together with the connected lid top 11 and lid base 6, is then placed back on the basket 4 to enclose the wet food in the basket 4.

The grip 19 of the handle 12 is then used to rotate the handle 12. As the handle 12 is rotated, the third, second, and first gears 9, 8 and 7 rotate, the basket top 5 rotates, and, with it, the basket 4 is rotated and spins. As the basket 4 spins, the centrifugal force imparted to the spinning food forces the water or moisture out through the holes 4a in the side of the basket 4. As the water or other liquid is forced out through the holes 4a it goes into the bowl 3 and collects in the bottom of the bowl 3.

After the water or other liquid has been spun from the food, the button 25 is pressed to activate the brake 10. When the button 25 is pressed, the brake frame 22 is moved downward into contact with the flat surface 37 on top of the lower portion 33 of second gear 8 and friction is created therebetween. When friction is created between the brake 10 and the flat surface 37, the second gear 8, as well first and third gears 7 and 9, are slowed, eventually to a stop. When the gears 7, 8, and 9 are slowed and stopped, the basket top 5 and basket 4 also slows and stops spinning. The button 25 is then release to disengage the brake 10.

When the basket 4 stops spinning, the basket top 5 (and with it the lid top 11 and lid base 6) are removed from the spinner 1, and the basket 4 containing the dried food is removed from the bowl 3. The suction device 39 is then deactivated by moving the handle 62 of the suction device 39 in the slot 59 in the side 56 of the base 2 to relieve the partial vacuum under the central portion 68 of the suction pad 60. The food spinner 1 and bowl 3 may then be lifted and the collected liquid poured out of the bowl 3.

The lid top 11 and connected lid base 6 and basket top 5 may then be replaced on the food spinner 1, and the food spinner 1 may be placed in its storage location.

It is understood that while certain forms of this invention have been illustrated and described, it is not limited thereto except insofar as such limitations are included in the following claims and allowable equivalents thereof.

What is claimed is as follows:

1. A food spinner assembly comprising:
(a) a lid assembly that houses a brake and at least two rotatably interconnected gears;
(b) the brake movable into frictional contact with at least one of the gears to slow the rotation of the at least two gears.

2. The food spinner of claim 1 wherein at least one of the rotatably interconnected gears is connected to a basket cover that is frictionally fit on top of a basket.

3. The food spinner of claim 2 wherein, when the brake is moved into frictional contact with at least one of the gears, the basket cannot rotate.

4. The food spinner of claim 2 wherein, when the at least two gears rotate, the basket rotates.

5. The food spinner of claim 2 wherein, when the brake is moved into contact with at least one of the interconnected gears, the rotation of the basket is slowed

6. The food spinner of claim 1 wherein the brake is moved into frictional contact with at least one of the gears by pressing a button attached to the brake.

7. The food spinner of claim 1 in which the lid assembly has a rotatable handle connected to at least one of the rotatably interconnected gears.

8. The food spinner of claim 7 wherein, when the handle is rotated, the basket rotates.

9. The food spinner of claim 1 wherein at least one of the gears is connected to a basket that fits rotatably within a bowl.

10. The food spinner of claim 9 wherein the bowl is connected to a base that houses a suction device.

11. The food spinner of claim 1 wherein a frictional material selected from a group comprising rubber, plastic, and metal is attached to a side of the brake that moves into contact with at least one of the rotatably interconnected gears.

12. A food spinner comprising:
(a) a lid assembly containing a brake and at least two rotatably interconnected gears;
(b) a basket rotatably connected to at least one of the rotatably interconnected gears;
(c) a rotatable handle connected to at least one of the rotatably interconnected gears to rotate the basket; and
(d) the brake moveable into frictional contact with at least one of the rotatably interconnected gears to slow and stop the rotation of the basket.

13. The food spinner of claim 12 wherein the basket rotates in a bowl attached to a base containing a suction device that is removably attachable to a work surface.

14. The food spinner of claim 13 wherein the suction device is attached to the work surface by moving a handle in a slot in the base.

15. The food spinner of claim 12 wherein the brake is moved into frictional contact with at least one of the rotatably interconnected gears by pressing a button on the lid assembly.

16. The food spinner of claim 15 wherein the button is spring biased to move the brake out of contact with the at least one rotatably interconnected gear when the pressing of the button ceases.

17. The food spinner of claim 12 wherein the basket has a friction fit lid that is connected to at least one of the rotatably interconnected gears.

18. The food spinner of claim 12 wherein a frictional material selected from a group comprising rubber, plastic, and metal is attached to a side of the brake that moves into contact with at least one of the rotatably interconnected gears.

19. A method of removing moisture from food in a spinner, the method comprising:
(a) providing a spinner assembly comprising:
(i) a rotatable basket connected to a rotatable gear that rotates the basket;
(ii) a brake moveable into contact with the gear so as to slow and stop the rotation of the basket;
(b) placing food in the basket, the food containing moisture;
(c) rotating the basket to remove moisture from the food;
(d) moving the brake into contact with the gear to slow and stop the rotation of the basket; and
(e) removing the food from the basket.

20. The method of claim 19, wherein the gear is connected to a handle, and the basket is rotated by rotating the handle.

21. The method of claim 19 wherein the spinner has a lid, the lid has a button, and the brake is moved into contact with the gear by pressing the button.

22. The method of claim 19 wherein the spinner has a base, the base contains a suction device, and the spinner is secured to a work surface by engaging the suction device before the basket is rotated.
